(19) United States
(12) Patent Application Publication
(10) Pub. No.: US 2011/0251881 A1
(43) Pub. Date: Oct. 13, 2011

(54) METHODS AND SYSTEMS FOR AMOUNT CALCULATION

(76) Inventor: Jeffery Maine, Lake St. Louis, MO (US)

(21) Appl. No.: 12/755,973

(22) Filed: Apr. 7, 2010

(51) Int. Cl. G06Q 30/00

(52) U.S. Cl. 705/14.16

(57) ABSTRACT

Methods and systems for amount calculation are described. In one embodiment, a determination that a participant has a referral relationship with a first merchant may be made. A first processing fee of the first merchant may be obtained. The first processing fee may be based on a payment volume of the first merchant. A second processing fee of the second merchant may be obtained. The second processing fee may be based on the payment volume of the second merchant. A rebate amount for the participant may be calculated based on the first processing fee, the second processing fee, and a determination that the participant has the referral relationship with the first merchant. Additional methods and systems are disclosed.

### FIELD

This application relates to methods and systems for financial processing, and more specifically to methods and systems for determining rebates based on referral relationships.

### BACKGROUND

Merchants include businesses that accepted credit cards, debit cards, and/or gifts cards for transaction processing. Credit cards may include, by way of example, VISA, MASTERCARD, DISCOVER, AMERICAN EXPRESS, JCB, DINER'S CLUB, and the like. The merchants may process the cards through card processing hardware, a virtual terminal, through a website, over the telephone, or the like.

When merchants sign up for merchant services to be able to processes cards for payments, the merchants are typically provided with a merchant account. The merchants may use their merchant accounts including a merchant ID number for card processing.

Merchants may contact and contract with an entity to provide transaction processing for their business. The merchant may have a contract directly with a card processor to provide transaction processing or indirectly with a card processor through a sales organization. Examples of card processors include First American Payment Systems (FAPS), National Processing Corporation (NPC), and First Data. The card processor has an affiliation with one or more banks that underwrite the credit card accounts and, in general, are affiliated with a credit card network such as MASTERCARD, VISA, or AMERICAN EXPRESS.

The merchants may pay the card processor a certain amount for the various card transactions it processes. The amount may be a fixed fee, a percentage of the transaction amount, based on the category of interchange, or otherwise. Typically, the amount does not include interchange fees, but does include credit and debit card payment processor fees. Processor fees include fees paid to the card processing network and the issuing bank and any dues or assessments associated with the providing of these merchant services.

If the contract for the transaction processing is between the merchant and the sales organization, the card processor may bill the merchant directly for all money due and pay the sales organization an amount (e.g., a percentage or a fixed fee) based on the transaction volume of the merchant.

### BRIEF DESCRIPTION OF THE DRAWINGS

FIG. 1 is a block diagram of an example system, according to an example embodiment;

FIG. 2 is a block diagram of an example operator device that may be deployed within the system of FIG. 1, according to an example embodiment;

FIG. 3 is a block diagram of an example data processing device that may be deployed within the system of FIG. 1, according to an example embodiment;

FIG. 4 is a block diagram of an example merchant services processing device that may be deployed within the system of FIG. 1, according to an example embodiment;

FIG. 5 is a block diagram of an example processing subsystem that may be deployed within the operator device of FIG. 2, the data processing device of FIG. 3, and/or the merchant services processing device of FIG. 3, according to an example embodiment;

FIG. 6 is a block diagram of a flowchart illustrating a method for rebate amount calculation, according to an example embodiment;

FIG. 7 is a diagram of referral relationships, according to an example embodiment;

FIG. 8 is a block diagram of a flowchart illustrating a method for rebate amount calculation, according to an example embodiment;

FIG. 9 is a diagram of referral relationships, according to an example embodiment;

FIG. 10 is a block diagram of a flowchart illustrating a method for rebate amount calculation, according to an example embodiment;

FIGS. 11-17 are diagrams of referral relationships, according to an example embodiment; and

FIG. 18 is a block diagram of a machine in the example form of a computer system within which a set of instructions for causing the machine to perform any one or more of the methodologies discussed herein may be executed.

### DETAILED DESCRIPTION

Example methods and systems for amount calculation are described. In the following description, for purposes of explanation, numerous specific details are set forth in order to provide a thorough understanding of example embodiments. It will be evident, however, to one of ordinary skill in the art that embodiments of the invention may be practiced without these specific details.

In general, participants and merchants are provided with rebates based on having a referral relationship with other merchants. The amount of the rebate is paid based on the processing fees paid by the merchants. In some embodiments, the rebate is a portion of the amount of money from a merchant that is ultimately paid to the sales organization or the card processor. For example, if a merchant pays a total of $309 in processor fees, $44.16 may be paid to the sales organization. The remaining amount of the $309 goes to goes to the payment processor. The rebate portion may then be a percentage of the amount of money paid to the sales organization. The rebate amount may exceed the amount of money paid to the sales organization based on the referral relationship that it has with merchants and the referral relationships its referred merchants have with other merchants.

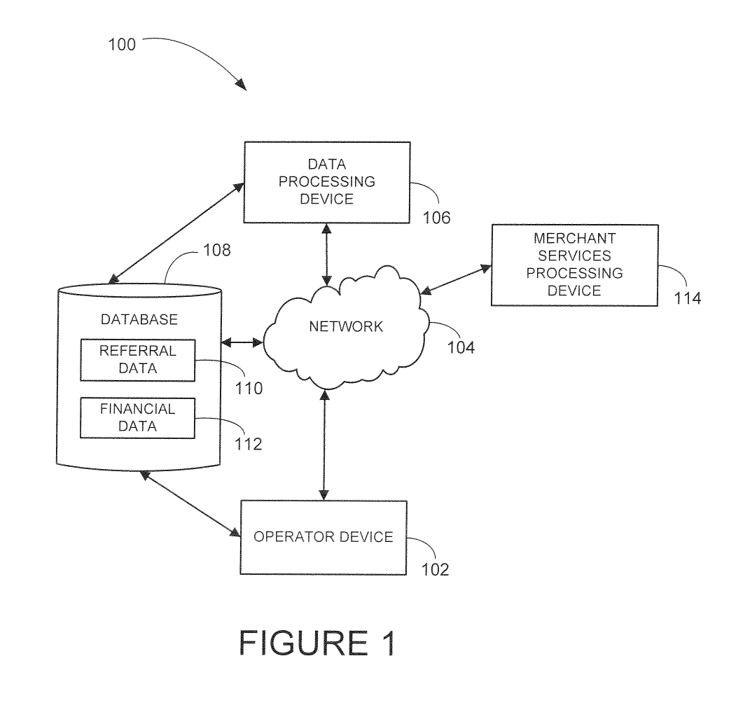

FIG. 1 illustrates an example system 100 in which amount calculation may be performed. The system 100 is an example platform in which one or more embodiments of the methods may be used. However, the amount calculation may also be performed on other platforms.

An operator may perform the amount calculation by using the operator device 102. The amount calculation may be performed on behalf of a client of the operator, an organization associated with the operator, or may otherwise be performed.

The operator may use the operator device 102 as a stand-alone device to perform the amount calculation, or may use the operator device 102 in combination with a data processing device 106 available over a network 104. The operator device 102 may be in a client-server relationship with the data processing device 106, a peer-to-peer relationship with the data processing device 106, or in a different type of relationship with the data processing device 106. In one embodiment, the client-service relationship may include a thin client on the operator device 102. In another embodiment, client-service relationship may include a thick client on the operator device 102.

The network 104 over which the operator device 102 and the data processing device 106 may communicate include, by way of example, a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

The operator may work on behalf of a sales organization (e.g., an independent sales organization (ISO)), a card processor, a bank, a consulting organization, or a different organization and may directly or indirectly control or operate the operator device 102, the data processing device 106, or both.

In one embodiment, the data processing device 106 is a single device. In one embodiment, the processing device 106 may include multiple computer systems. For example, the processing device 106 may include multiple computer systems in a cloud computing configuration.

The operator device 102, the data processing device 106, or both may communicate with a database 108. The database 108 may include referral data 110 and/or financial data 112.

The referral data 110 stores referral relationships between a participant and merchants or among multiple merchants. The participant may be a merchant or a sales person that does not qualify as a merchant. In general, a merchant is a person that accepts cards (e.g., credit cards and/or debit cards) for services offered by the merchant and/or goods sold by the merchant. The participant or a merchant may have a referral relationship with a merchant by referring the merchant to a provider of card processing services. The provider may be a direct provider of the card processing services, or may be an indirect provider (e.g., a sales organization) on behalf of a provider of card processing services. The referral relationship establishes that, in accordance with the terms of the provider of the card processing services, the participant or merchant has referred a merchant to the provider.

The financial data 112 stores financial data regarding the provider's providing of card processing services. The financial data 112 may include the amount of rebates paid to participants and merchants for providing referrals, the amounts of processing fees of merchants, and the like.

In some embodiments, a merchant services processing device 114 may be included in the network 104. A card processor may operate the merchant services processing device 114. The card processor provides merchant services to enable card processing. The data processing device 106 may be operated by a sales organization or the card processor. Certain financial data 112 stored in the database 108 may be received from the merchant services provider. In some embodiments, the merchant services processing device 114 and the data processing device 106 may be made integral in a single device.

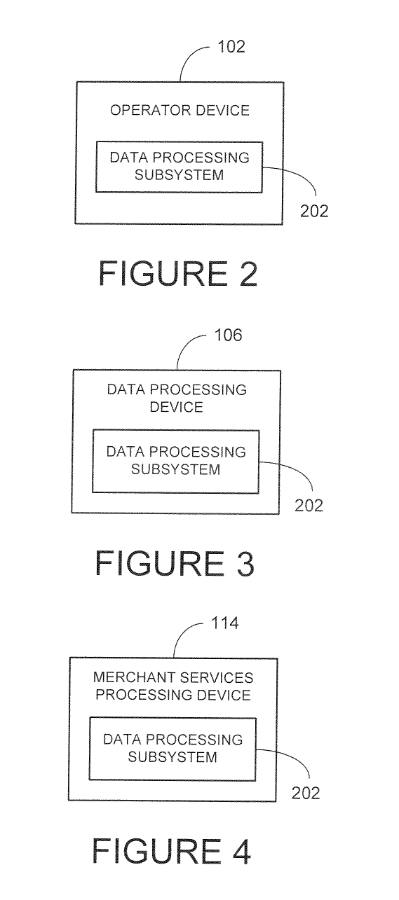

FIG. 2 illustrates an example operator device 102 that may be deployed in the system 100 (see FIG. 1), or otherwise deployed in another system. The operator device 102 is shown to include a data processing subsystem 202. The data processing subsystem 202 determines the rebate amount for the participant based on referral relationships with various merchants.

FIG. 3 illustrates an example data processing device 106 that may be deployed in the system 100 (see FIG. 1), or otherwise deployed in another system. In this embodiment, the data processing device 106 is shown to include the data processing subsystem 202 (see FIG. 2).

FIG. 4 illustrates an example merchant services processing device 114 that may be deployed in the system 100 (see FIG. 1), or otherwise deployed in another system. In this embodiment, the merchant services processing device 114 is shown to include the data processing subsystem 202 (see FIG. 2).

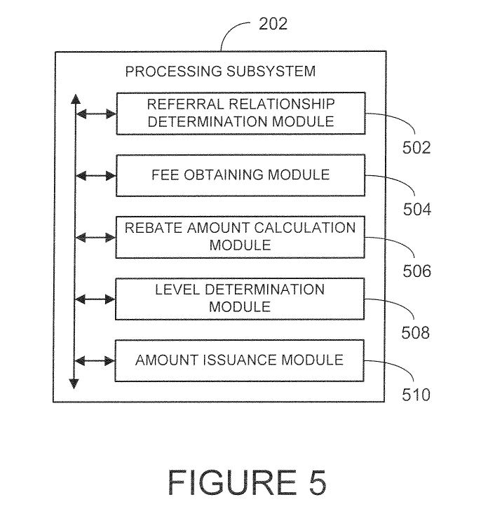

FIG. 5 illustrates an example processing subsystem 202 that may be deployed in the operator device 102, the processing device 106, the merchant services processing device 114, or otherwise deployed in another system. One or more modules are included in the processing subsystem 202 to determine a rebate amount. The modules of the processing subsystem 202 that may be included are a referral relationship determination module 502, a fee obtaining module 504, a rebate amount calculation module 506, a level determination module 508, and an amount issuance module 510. Other modules may also be included.

The referral relationship determination module 502 determines that a participant or a merchant has a referral relationship with another merchant. To have the referral relationship, the participant or merchant is deemed responsible for having a merchant sign up with a card processor or merchant services organization to receive merchant services.

In general, the participant or merchant is deemed responsible based on criteria established by the card processor or sales organization. In some embodiments, the determination by the referral relationship determination module 502 includes accessing a referral list and determining that the participant is associated with the merchant or that the merchant is associated with another merchant on the referral list.

The fee obtaining module 504 obtains a processing fee or a processing amount of the merchant based on a payment volume of the merchant. In some embodiments, the processing fee is obtained by calculating the processing fee of the merchant based on the payment volume of the merchant. In other embodiments, the processing fee is obtained by receiving the processing fee of the merchant from a card processor.

The rebate amount calculation module 506 calculates a rebate amount for the participant or a merchant based on applicable processing fees or applicable processing amounts and a determination of certain referral relationships.

In one embodiment, the rebate amount is calculated by calculating and summing applicable rebate portions. A rebate portion is calculated by taking a percentage of the applicable processing fee.

Certain limitations may be set on when the participant and merchants are entitled to a rebate. For example, the participant and the merchants may, in some embodiments, earn rebates only when they have referral relationships with at least two downstream merchants. Downstream merchants are merchants that have been referred to the card processing services offered by the provider by another merchant or participant. In some embodiments, the rebate may only be earned when the relationship with the at least two downstream merchants is direct. In some embodiments, the rebate may only be earned when the relationship with the at least two downstream merchants is direct or indirect. Other configurations and limitations may also be set.

In some embodiments, a level determination module 508 determines whether a maximum further referral level has been exceeded between a participant and a merchant or between two merchants. The maximum referral level defines a number of levels of indirect referrals from which the participant may be entitled to a rebate. When the maximum further referral level has been exceeded, the rebate amount calculation module 506 may exclude from consideration certain merchants that have too tangential of a relationship with the merchant responsible for the processing fees or the processing amounts.

The amount issuance module 510 issues an amount of money to the participant or a merchant for the rebate amount based on the calculation performed by the rebate amount calculation module 506. The amount may be issued in the form of a credit or another type of payment.

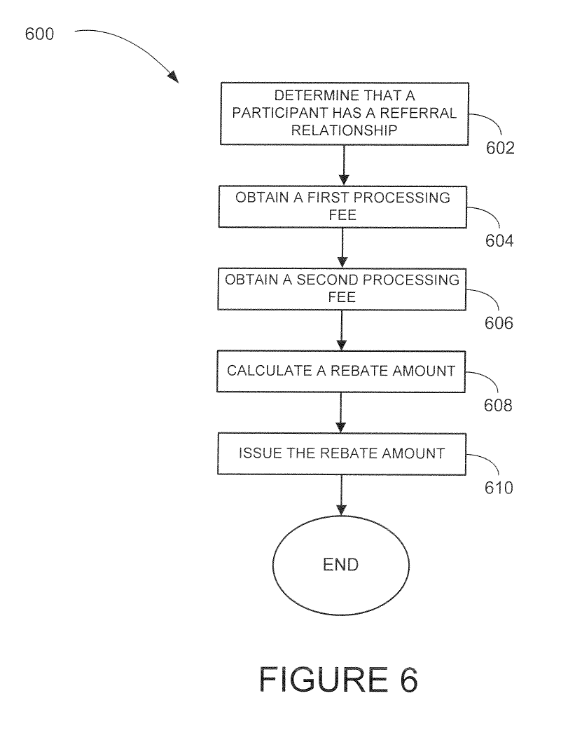

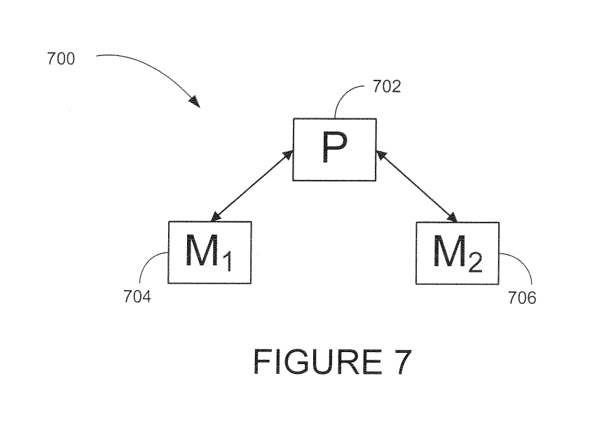

FIG. 6 illustrates a method 600 for rebate amount calculation, according to an example embodiment. FIG. 7. is an example diagram 700 of the referral relationships used in performing the method 600, according to an example embodiment. The method 600 may be performed by the operator device 102, the processing device 106, and/or the merchant services processing device 114 of the system 100 (see FIG. 1), or may be otherwise performed.

A determination that a participant 702 has the referral relationship with a first merchant 704 and a second merchant 706 is made at block 602. The first merchant 704 and the second merchant 706 are shown in the diagram 700 as being directly downstream from the participant 702.

In some embodiments, the determination includes accessing a referral list from the referral data 110 (see FIG. 1) and determining that the participant 702 is associated with the first merchant 704 and the second merchant 706 on the referral list.

A first processing fee of the first merchant 704 is obtained at block 604. The first processing fee is based on a payment volume of the first merchant 704. In some embodiments, the processing fee is obtained by calculating the first processing fee of the first merchant 704 based on the payment volume of the first merchant 704. In some embodiments, the processing fee is obtained by receiving the first processing fee of the first merchant 704 from the merchant services provider.

A second processing fee of the second merchant 706 is obtained at block 606. The second processing fee is based on the payment volume of the second merchant 706. In some embodiments, the processing fee is obtained by calculating the second processing fee of the second merchant 706 based on the payment volume of the second merchant 706. In some embodiments, the processing fee is obtained by receiving the second processing fee of the second merchant 706 from the merchant services provider.

At block 608, a fee amount for the participant 702 is calculated based on the first processing fee, the second processing fee, and a determination that the participant 702 has referral relationships with the first merchant 704 and the second merchant 706.

In some embodiments, the calculation of the rebate amount includes calculating a first rebate portion by taking a first percentage of the first processing fee, calculating a second rebate portion by taking a second percentage of the second processing fee, and summing the first rebate portion and the rebate portion to determine the rebate amount.

In some embodiments, the first percentage may be the same percentage as the second percentage. In other embodiments, the first percentage may be a different percentage than the second percentage.

The rebate amount may be issued to the participant 702 at block 610. The amount may be issued as a credit, payment in the form of an ACH (Automated Clearing House) payment, payment in the form of an issued check, or otherwise.

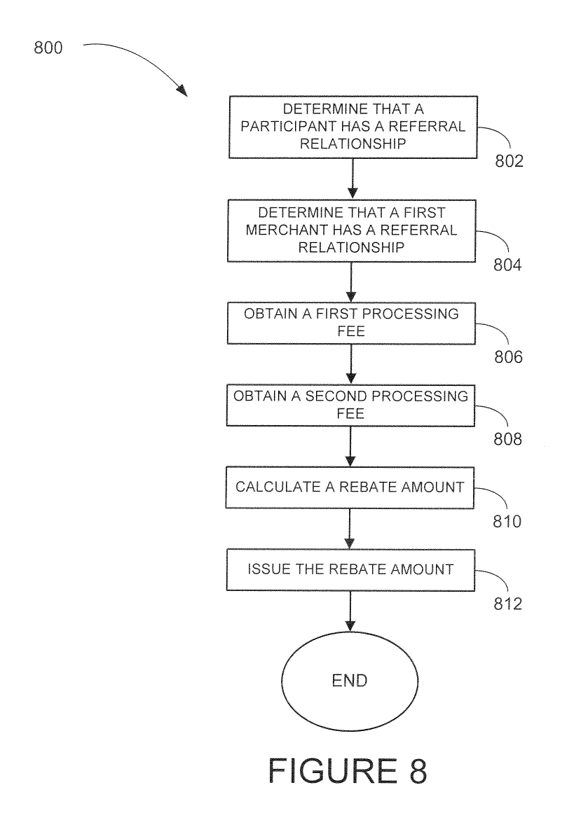

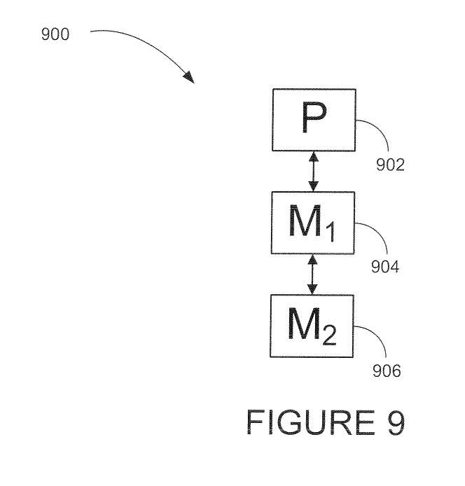

FIG. 8 illustrates a method 800 for rebate amount calculation, according to an example embodiment. FIG. 9. is an example diagram 900 of the referral relationships used in performing the method 800, according to an example embodiment. The method 800 may be performed by the operator device 102, the processing device 106, and/or the merchant services processing device 114 of the system 100 (see FIG. 1), or may be otherwise performed.

A determination that a participant 902 has a referral relationship with a first merchant 904 is made at block 802. The first merchant 904 is shown in the diagram 900 as being directly downstream from the participant 902.

A determination that the first merchant 904 has the referral relationship with a second merchant 906 is made at block 804. The second is shown in the diagram 900 as being directly downstream from the first merchant 904 and indirectly downstream from the participant 902.

A first processing fee of the first merchant 904 is obtained at block 806. The first processing fee is based on a payment volume of the first merchant 904.

A second processing fee of the second merchant 906 is obtained at block 808. The second processing fee based on the payment volume of the second merchant 906.

At block 810, a rebate amount for the participant 902 is calculated based on the first processing fee, the second processing fee, and a determination that the participant 902 has the referral relationship with the first merchant 904 and that the first merchant 904 has the referral relationship with the second merchant 906.

The rebate amount may be issued to the participant 902 at block 812.

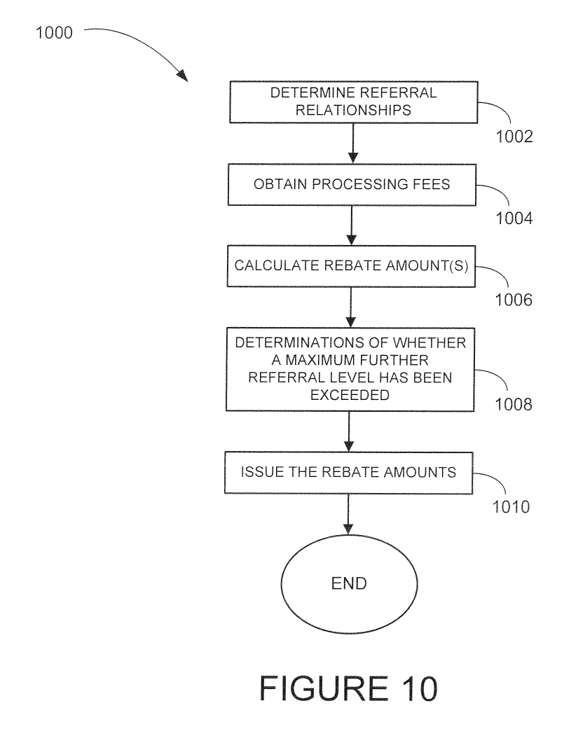

FIG. 10 illustrates a method 1000 for rebate amount calculation, according to an example embodiment. The method 1000 may be performed by the operator device 102, the processing device 106, and/or the merchant services processing device 114 of the system 100 (see FIG. 1), or may be otherwise performed.

At block 1002, referral relationships between the participant and merchants and the referral relationships among the merchants are determined.

Processing fees of the merchants may be obtained at block 1004. The processing fees are based on payment volumes of the merchants. The processing fees may be received from the merchant services provider, calculated, or otherwise obtained. In one embodiment, the processing amount is obtained at block 1004 from the merchant services provider, the card processor, or another instead of the actual processing fees.

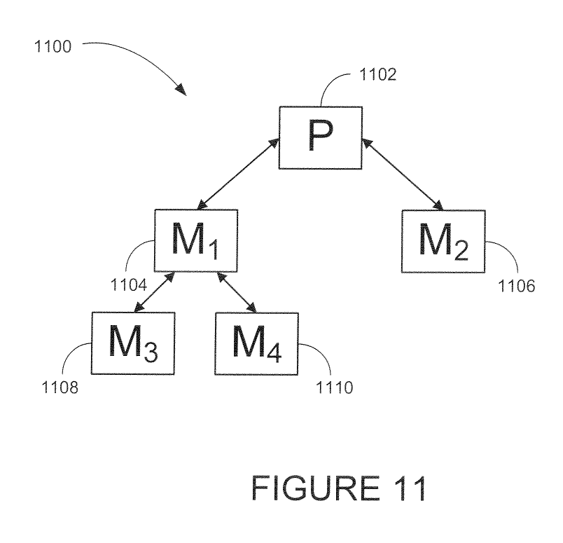

Rebate amounts are calculated at block 1006. The rebate amount is based on the referral relationships and processing fees of merchants involved in the referral relationships. In some embodiments, the participant and the merchants earn rebates when they have referral relationships with at least two downstream merchants. Examples of referral relationships and associated rebate amount calculations in performing the method 1000 are shown in FIGS. 11-17.

Determinations of whether a maximum further referral level has been exceeded between a participant and a merchant or between two merchants may be made at block 1008. When the maximum further referral level has been exceeded, processing fees or the processing amounts of certain merchants that have too tangential of a relationship with the merchant or participant may be excluded from the rebate amount with the merchant or participant.

At block 1010, the rebate amounts may be issued.

FIG. 11. is an example diagram 1100 of the referral relationships used in performing the method 1000, according to an example embodiment. The diagram 1100 includes a participant 1102, a first merchant 1104, a second merchant 1106, a third merchant 1108, and a fourth merchant 1110.

In the diagram 1100, the participant 1102 is shown to have the referral relationship with the first merchant 1104 and the second merchant 1106. The first merchant 1104 is shown to have the referral relationship with the third merchant 1108 and the fourth merchant 1110. No other referral relationships are shown to exist in the diagram 1100.

The first merchant 1104 and the second merchant 1106 are directly downstream from the participant 1102. The third merchant 1108 and the fourth merchant 110 are directly downstream from the first merchant 1104 and indirectly downstream from the participant 1102.

If the rebate earning limitation is that the participant 1102 or one of the merchants 1104-1110 have at least two downstream participants, then the participant 1102 and the first merchant 1104 are eligible to earn rebates. In some embodiments, the rebate earning limitation is how many merchants the merchant or participant have a referral relationship to qualify for rebate.

The rebate amount of the participant 1102 will then be based on the processing fees or processing amounts of the merchants 1104-1110. The rebate amount of the first merchant 1104 will then be based on the processing fees or processing amounts of the merchants 1108, 1110.

The rebate amount attributable to the processing fees generated by the third merchant 1108 and the fourth merchant 1110 may be the same for the participant 1102 and the first merchant 1104 or different for the participant 1102 and the first merchant 1104. For example, the percentage of the processing fees of the third merchant 1108 and the fourth merchant 1110 that is included in the rebate amount of the participant 1102 and the first merchant 1104 may be the same or different. The different percentages may be based on the total number of levels associated with the participant or the merchant 1104, the total number of downstream merchants, the total number of direct downstream merchants, or on other factors.

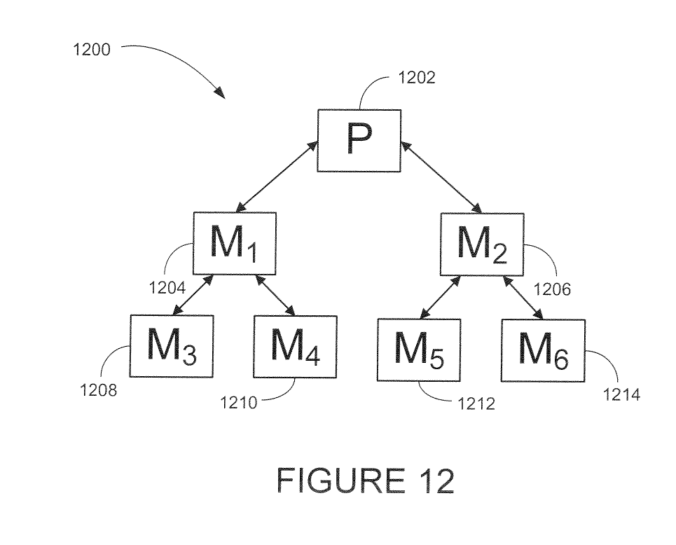

FIG. 12. is an example diagram 1200 of the referral relationships used in performing the method 1000, according to an example embodiment. The diagram 1200 includes a participant 1202, a first merchant 1204, a second merchant 1206, a third merchant 1208, a fourth merchant 1210, a fifth merchant 1212, and a sixth merchant 1214.

In the diagram 1200, the participant 1202 is shown to have the referral relationship with the first merchant 1204 and the second merchant 1206. The first merchant 1204 is shown to have the referral relationship with the third merchant 1208 and the fourth merchant 1210. The second merchant 1206 is shown to have the referral relationship with the fifth merchant 1212 and the sixth merchant 1214. No other referral relationships are shown to exist in the diagram 1200.

The first merchant 1204 and the second merchant 1206 are directly downstream from the participant 1202. The third merchant 1208 and the fourth merchant 1210 are directly downstream from the first merchant 1204 and indirectly downstream from the participant 1202. The fifth merchant 1212 and the sixth merchant 1214 are directly downstream from the first merchant 1204 and indirectly downstream from the participant 1202.

If the rebate earning limitation is that the participant 1202 or one of the merchants 1204-1214 have at least two downstream participants, then the participant 1202, the first merchant 1204, and the second merchant 1206 are eligible to earn rebates.

The rebate amount of the participant 1202 will then be based on the processing fees or processing amounts of the merchants 1204-1214. The rebate amount of the first merchant 1204 will then be based on the processing fees or processing amounts of the merchants 1208, 1210. The rebate amount of the second merchant 1204 will then be based on the processing fees or processing amounts of the merchants 1212, 1214.

The rebate amount attributable to the processing fees generated by the third merchant 1208 and the fourth merchant 1210 may be the same for the participant 1202 and the first merchant 1204 or different for the participant 1202 and the first merchant 1204.

The rebate amount attributable to the processing fees generated by the fifth merchant 1212 and the sixth merchant 1214 may be the same for the participant 1202 and the second merchant 1206 or different for the participant 1202 and the second merchant 1206.

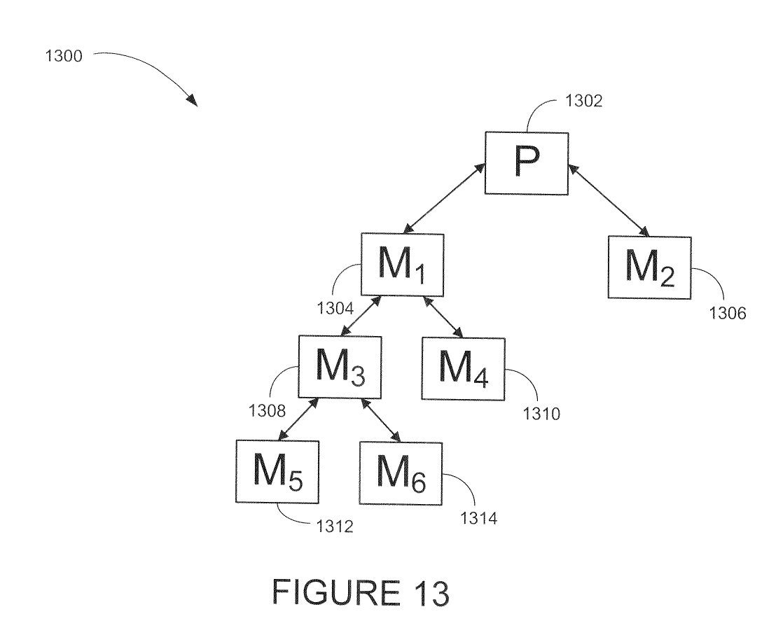

FIG. 13. is an example diagram 1300 of the referral relationships used in performing the method 1000, according to an example embodiment. The diagram 1300 includes a participant 1302, a first merchant 1304, a second merchant 1306, a third merchant 1308, a fourth merchant 1310, a fifth merchant 1312, and a sixth merchant 1314.

In the diagram 1300, the participant 1302 is shown to have the referral relationship with the first merchant 1304 and the second merchant 1306. The first merchant 1304 is shown to have the referral relationship with the third merchant 1308 and the fourth merchant 1310. The third merchant 1308 is shown to have the referral relationship with the fifth merchant 1312 and the sixth merchant 1314. No other referral relationships are shown to exist in the diagram 1300.

The first merchant 1304 and the second merchant 1306 are directly downstream from the participant 1302. The third merchant 1308 and the fourth merchant 1310 are directly downstream from the first merchant 1304 and indirectly downstream from the participant 1302. The fifth merchant 1312 and the sixth merchant 1314 are directly downstream from the third merchant 1308 and indirectly downstream from the participant 1302 and the first merchant 1304.

If the rebate earning limitation is that the participant 1302 or one of the merchants 1304-1314 have at least two downstream participants, then the participant 1302, the first merchant 1304, and the third merchant 1308 are eligible to earn rebates.

The rebate amount of the participant 1302 will then be based on the processing fees or processing amounts of the merchants 1304-1314. However, if there is a maximum level limitation of two, then the rebate amount for the participant 1032 will be based on the processing fees or processing amounts of the merchants 1304-1310.

The rebate amount of the first merchant 1304 will then be based on the processing fees or processing amounts of the merchants 1308, 1312, 1314. The rebate amount of the third merchant 1308 will then be based on the processing fees or processing amounts of the merchants 1312, 1314.

The rebate amount attributable to the processing fees generated by the third merchant 1308 and the fourth merchant 1310 may be the same for the participant 1302 and the first merchant 1304 or different for the participant 1302 and the first merchant 1304.

The rebate amount attributable to the processing fees generated by the fifth merchant 1312 and the sixth merchant 1314 may be the same for the participant 1302, the first merchant 1304, and/or the third merchant 1308 or different for the participant 1302, the first merchant 1304, and/or the third merchant 1308.

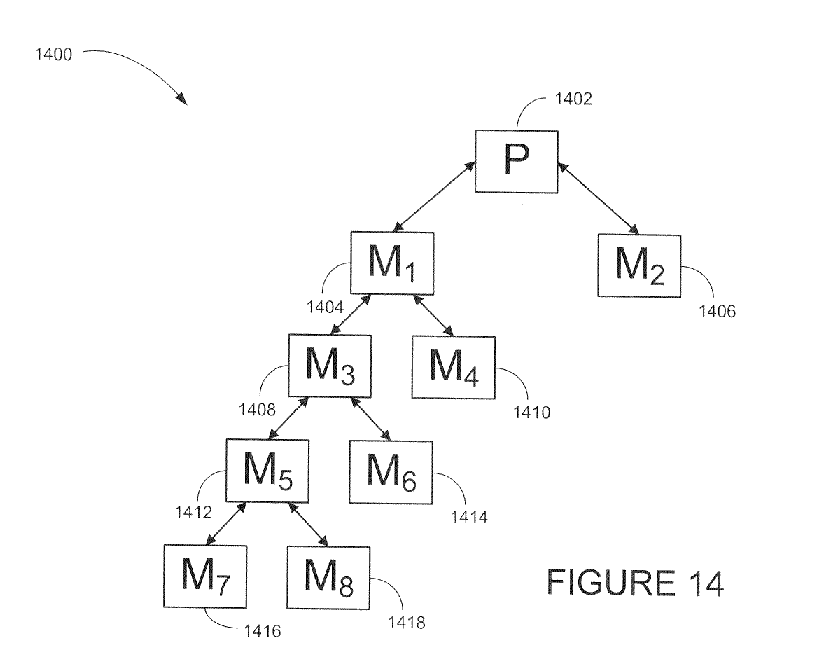

FIG. 14. is an example diagram 1400 of the referral relationships used in performing the method 1000, according to an example embodiment. The diagram 1400 includes a participant 1402, a first merchant 1404, a second merchant 1406, a third merchant 1408, a fourth merchant 1410, a fifth merchant 1412, and a sixth merchant 1414, a seven merchant 1416, and an eighth merchant 1418.

In the diagram 1400, the participant 1402 is shown to have the referral relationship with the first merchant 1404 and the second merchant 1406. The first merchant 1404 is shown to have the referral relationship with the third merchant 1408 and the fourth merchant 1410. The third merchant 1408 is shown to have the referral relationship with the fifth merchant 1412 and the sixth merchant 1414. The fifth merchant 1412 is shown to have the referral relationship with the seventh merchant 1416 and the eighth merchant 1418. No other referral relationships are shown to exist in the diagram 1400.

The first merchant 1404 and the second merchant 1406 are directly downstream from the participant 1402. The third merchant 1408 and the fourth merchant 1410 are directly downstream from the first merchant 1404 and indirectly downstream from the participant 1402. The fifth merchant 1412 and the sixth merchant 1414 are directly downstream from the third merchant 1408 and indirectly downstream from the participant 1402 and the first merchant 1404. The seventh merchant 1416 and the eighth merchant 1418 are directly downstream from the fifth merchant 1412 and indirectly downstream from the participant 1402, the first merchant 1404, and the third merchant 1408.

If the rebate earning limitation is that the participant 1402 or one of the merchants 1404-1414 have at least two downstream participants, then the participant 1402, the first merchant 1404, the third merchant 1408, and the fifth merchant 1412 are eligible to earn rebates.

The rebate amount of the participant 1402 may be based on the processing fees or processing amounts of the merchants 1404-1418. However, if there is a maximum level limitation of two, then the rebate amount for the participant 1402 will be based on the processing fees or processing amounts of the merchants 1404-1410. If there is a maximum level limitation of three, then the rebate amount for the participant 1402 will be based on the processing fees or processing amounts of the merchants 1404-1414.

The rebate amount of the first merchant 1404 will then be based on the processing fees or processing amounts of the merchants 1408-1418. However, if there is a maximum level limitation of two, then the rebate amount for the first merchant 1404 will be based on the processing fees or processing amounts of the merchants 1408-1414.

The rebate amount of the third merchant 1408 may be based on the processing fees or processing amounts of the merchants 1412-1418. The rebate amount of the fifth merchant 1412 may be based on the processing fees or processing amounts of the merchants 1416, 1418.

The rebate amount attributable to the processing fees generated by the third merchant 1408 and the fourth merchant 1410 may be the same for the participant 1402 and the first merchant 1404 or different for the participant 1402 and the first merchant 1404.

The rebate amount attributable to the processing fees generated by the fifth merchant 1412 and the sixth merchant 1414 may be the same for the participant 1402, the first merchant 1404, and the third merchant 1408 or different for the participant 1402, the first merchant 1404, and the third merchant 1408.

The rebate amount attributable to the processing fees generated by the seventh merchant 1412 and the eighth merchant 1418 may be the same for the participant 1402, the first merchant 1404, the third merchant 1408, and/or the fifth merchant 1412 or different for the participant 1402, the first merchant 1404, the third merchant 1408, and/or the fifth merchant 1412.

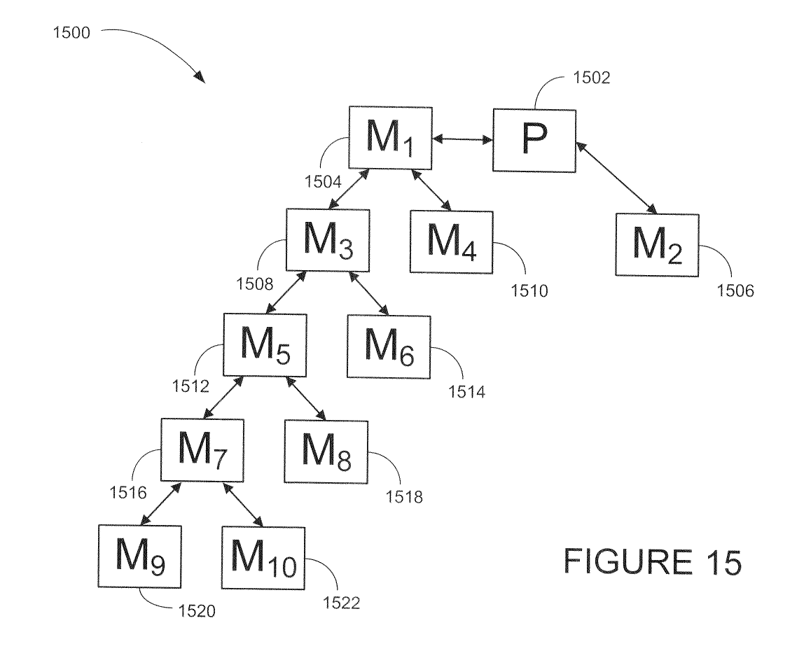

FIG. 15. is an example diagram 1500 of the referral relationships used in performing the method 1000, according to an example embodiment. The diagram 1500 includes a participant 1502, a first merchant 1504, a second merchant 1506, a third merchant 1508, a fourth merchant 1510, a fifth merchant 1512, and a sixth merchant 1514, a seven merchant 1516, an eighth merchant 1518, a ninth merchant 1520, and a tenth merchant 1522.

In the diagram 1500, the participant 1502 is shown to have the referral relationship with the first merchant 1504 and the second merchant 1506. The first merchant 1504 is shown to have the referral relationship with the third merchant 1508 and the fourth merchant 1510. The third merchant 1508 is shown to have the referral relationship with the fifth merchant 1512 and the sixth merchant 1514. The fifth merchant 1512 is shown to have the referral relationship with the seventh merchant 1516 and the eighth merchant 1518. The seventh merchant 1516 is shown to have the referral relationship with the ninth merchant 1520 and the tenth merchant 1522. No other referral relationships are shown to exist in the diagram 1500.

The first merchant 1504 and the second merchant 1506 are directly downstream from the participant 1502. The third merchant 1508 and the fourth merchant 1510 are directly downstream from the first merchant 1504 and indirectly downstream from the participant 1502. The fifth merchant 1512 and the sixth merchant 1514 are directly downstream from the third merchant 1508 and indirectly downstream from the participant 1502 and the first merchant 1504. The seventh merchant 1516 and the eighth merchant 1518 are directly downstream from the fifth merchant 1512 and indirectly downstream from the participant 1502, the first merchant 1504, and the third merchant 1508. The ninth merchant 1520 and the tenth merchant 1520 are directly downstream from the seventh merchant 1516 and indirectly downstream from the participant 1502, the first merchant 1504, the third merchant 1508, and the fifth merchant 1512.

If the rebate earning limitation is that the participant 1502 or one of the merchants 1504-1514 have at least two downstream participants, then the participant 1502, the first merchant 1504, the third merchant 1508, and the fifth merchant are eligible to earn rebates.

The rebate amount of the participant 1502 may be based on the processing fees or processing amounts of the merchants 1504-1522. However, if there is a maximum level limitation of two, then the rebate amount for the participant 1502 will be based on the processing fees or processing amounts of the merchants 1504-1510. If there is a maximum level limitation of three, then the rebate amount for the participant 1502 will be based on the processing fees or processing amounts of the merchants 1504-1514. If there is a maximum level limitation of four, then the rebate amount for the participant 1502 will be based on the processing fees or processing amounts of the merchants 1516-1518.

The rebate amount of the first merchant 1504 will then be based on the processing fees or processing amounts of the merchants 1508-1522. However, if there is a maximum level limitation of two, then the rebate amount for the first merchant 1504 will be based on the processing fees or processing amounts of the merchants 1508-1514. If there is a maximum level limitation of three, then the rebate amount for the first merchant 1504 will be based on the processing fees or processing amounts of the merchants 1516-1518.

The rebate amount of the third merchant 1508 may be based on the processing fees or processing amounts of the merchants 1512-1522. However, if there is a maximum level limitation of two, then the rebate amount for the third merchant 1508 will be based on the processing fees or processing amounts of the merchants 1512-1518.

The rebate amount of the fifth merchant 1512 may be based on the processing fees or processing amounts of the merchants 1516-1522. The rebate amount of the seventh merchant 1516 may be based on the processing fees or processing amounts of the merchants 1520-1522.

The rebate amount attributable to the processing fees generated by the third merchant 1508 and the fourth merchant 1510 may be the same for the participant 1502 and the first merchant 1504 or different for the participant 1502 and the first merchant 1504.

The rebate amount attributable to the processing fees generated by the fifth merchant 1512 and the sixth merchant 1514 may be the same for the participant 1502, the first merchant 1504, and the third merchant 1508 or different for the participant 1502, the first merchant 1504, and the third merchant 1508.

The rebate amount attributable to the processing fees generated by the seventh merchant 1512 and the eighth merchant 1518 may be the same for the participant 1502, the first merchant 1504, the third merchant 1508, and/or the fifth merchant 1512 or different for the participant 1502, the first merchant 1504, the third merchant 1508, and/or the fifth merchant 1512.

The rebate amount attributable to the processing fees generated by the ninth merchant 1520 and the tenth merchant 1520 may be the same for the participant 1502, the first merchant 1504, the third merchant 1508, the fifth merchant 1512, and/or the seventh merchant 1516 or different for the participant 1502, the first merchant 1504, the third merchant 1508, the fifth merchant 1512, and/or the seventh merchant 1516.

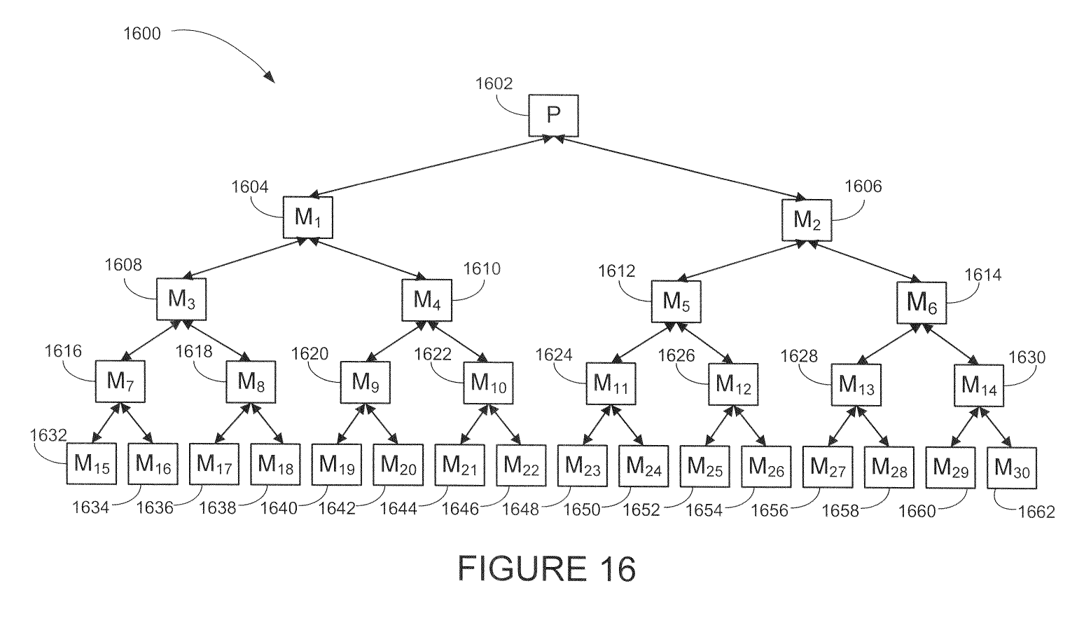

FIG. 16. is an example diagram 1600 of the referral relationships used in performing the method 1000, according to an example embodiment. The diagram 1600 includes a participant 1602, a first merchant 1604, a second merchant 1606, a third merchant 1608, a fourth merchant 1610, a fifth merchant 1612, and a sixth merchant 1614, a seven merchant 1616, an eighth merchant 1618, a ninth merchant 1620, a tenth merchant 1622, an eleventh merchant 1624, a twelfth merchant 1626, a thirteenth merchant 1628, a fourteenth merchant 1630, a fifteenth merchant 1632, a sixteenth merchant 1634, a seventeenth merchant 1636, an eighteenth merchant 1638, a nineteenth merchant 1640, a twentieth merchant 1642, a twenty-first merchant 1644, a twenty-second merchant 1646, a twenty-third merchant 1648, a twenty-fourth merchant 1650, a twenty-fifth merchant 1652, a twenty-sixth merchant 1654, a twenty-seventh merchant 1656, a twenty-eighth merchant 1658, a twenty-ninth merchant 1660, and a thirtieth merchant 1662.

In the diagram 1600, the participant 1602 is shown to have the referral relationship with the first merchant 1604 and the second merchant 1606. The first merchant 1604 is shown to have the referral relationship with the third merchant 1608 and the fourth merchant 1610. The second merchant 1606 is shown to have the referral relationship with the fifth merchant 1612 and the sixth merchant 1614.

The third merchant 1608 is shown to have the referral relationship with the seventh merchant 1616 and the eighth merchant 1618. The fourth merchant 1610 is shown to have the referral relationship with the ninth merchant 1620 and the tenth merchant 1622. The fifth merchant 1612 is shown to have the referral relationship with the eleventh merchant 1624 and the twelfth merchant 1626. The sixth merchant 1614 is shown to have the referral relationship with the thirteen merchant 1628 and the fourteenth merchant 1630.

The seventh merchant 1616 is shown to have the referral relationship with the fifteenth merchant 1632 and the sixteenth merchant 1634. The eighth merchant 1618 is shown to have the referral relationship with the seventeenth merchant 1636 and the eighteenth merchant 1638. The ninth merchant 1620 is shown to have the referral relationship with the nineteenth merchant 1640 and the twentieth merchant 1642. The tenth merchant 1622 is shown to have the referral relationship with the twenty-first merchant 1644 and the twenty-second merchant 1646. The eleventh merchant 1624 is shown to have the referral relationship with the twenty-third merchant 1648 and the twenty-fourth merchant 1650. The twelfth merchant 1626 is shown to have the referral relationship with the twenty-fifth merchant 1652 and the twenty-sixth merchant 1654. The thirteenth merchant 1626 is shown to have the referral relationship with the twenty-seventh merchant 1656 and the twenty-eighth merchant 1658. The fourteenth merchant 1628 is shown to have the referral relationship with the twenty-ninth merchant 1660 and the thirtieth merchant 1662.

The first merchant 1604 and the second merchant 1606 are directly downstream from the participant 1602. The third merchant 1608 and the fourth merchant 1610 are directly downstream from the first merchant 1604 and indirectly downstream from the participant 1602. The fifth merchant 1612 and the sixth merchant 1614 are directly downstream from the second merchant 1606 and indirectly downstream from the participant 1602.

The seventh merchant 1616 and the eighth merchant 1618 are directly downstream from the third merchant 1608 and indirectly downstream from the participant 1602 and the first merchant 1604. The ninth merchant 1620 and the tenth merchant 1620 are directly downstream from the fourth merchant 1610 and indirectly downstream from the participant 1602 and the first merchant 1604. The eleventh merchant 1624 and the twelfth merchant 1626 are directly downstream from the fifth merchant 1612 and indirectly downstream from the participant 1602 and the second merchant 1606. The thirteenth merchant 1628 and the fourteenth merchant 1630 are directly downstream from the sixth merchant 1614 and indirectly downstream from the participant 1602 and the second merchant 1606.

The fifteenth merchant 1632 and the sixteenth merchant 1634 are directly downstream from the seventh merchant 1616 and indirectly downstream from the participant 1602, the first merchant 1604, and the third merchant 1608. The seventeenth merchant 1636 and the eighteenth merchant 1638 are directly downstream from the eighth merchant 1618 and indirectly downstream from the participant 1602, the first merchant 1604, and the third merchant 1608. The nineteenth merchant 1640 and the twentieth merchant 1642 are directly downstream from the ninth merchant 1620 and indirectly downstream from the participant 1602, the first merchant 1604, and the fourth merchant 1610. The twenty-first merchant 1644 and the twenty-second merchant 1646 are directly downstream from the tenth merchant 1622 and indirectly downstream from the participant 1602, the first merchant 1604, and the fourth merchant 1610. The twenty-third merchant 1648 and the twenty-fourth merchant 1650 are directly downstream from the eleventh merchant 1624 and indirectly downstream from the participant 1602, the second merchant 1606, and the fifth merchant 1612. The twenty-fifth merchant 1652 and the twenty-sixth merchant 1654 are directly downstream from the twelfth merchant 1626 and indirectly downstream from the participant 1602, the second merchant 1606, and the fifth merchant 1612. The twenty-seventh merchant 1656 and the twenty-eighth merchant 1658 are directly downstream from the thirteenth merchant 1628 and indirectly downstream from the participant 1602, the second merchant 1606, and the sixth merchant 1614. The twenty-ninth merchant 1660 and the thirtieth merchant 1662 are directly downstream from the fourteenth merchant 1630 and indirectly downstream from the participant 1602, the second merchant 1606, and the sixth merchant 1614.

If the rebate earning limitation is that the participant 1602 or one of the merchants 1604-1614 have at least two downstream participants, then the participant 1602 and the merchants 1604-1630 are eligible to earn rebates.

The rebate amount of the participant 1602 may be based on the processing fees or processing amounts of the merchants 1604-1662. However, if there is a maximum level limitation of two, then the rebate amount for the participant 1602 will be based on the processing fees or processing amounts of the merchants 1604-1614. If there is a maximum level limitation of three, then the rebate amount for the participant 1602 will be based on the processing fees or processing amounts of the merchants 1604-1630.

The rebate amount of the first merchant 1604 will then be based on the processing fees or processing amounts of the merchants 1608, 1610, 1616-1622, 1632-1646. However, if there is a maximum level limitation of two, then the rebate amount for the first merchant 1604 will be based on the processing fees or processing amounts of the merchants 1608, 1610, 1616-1622.

The rebate amount of the second merchant 1606 will then be based on the processing fees or processing amounts of the merchants 1612, 1614, 1624-1630, 1648-1662. However, if there is a maximum level limitation of two, then the rebate amount for the second merchant 1606 will be based on the processing fees or processing amounts of the merchants 1612, 1614, 1624-1630.

The rebate amount of the third merchant 1608 may be based on the processing fees or processing amounts of the merchants 1616, 1618, 1632-1638. The rebate amount of the fourth merchant 1610 may be based on the processing fees or processing amounts of the merchants 1620, 1622, 1640-1646. The rebate amount of the fifth merchant 1612 may be based on the processing fees or processing amounts of the merchants 1624, 1626, 1648-1654. The rebate amount of the sixth merchant 1614 may be based on the processing fees or processing amounts of the merchants 1628, 1630, 1656-1662.

The rebate amount of the seventh merchant 1616 may be based on the processing fees or processing amounts of the merchants 1632, 1634. The rebate amount of the eighth merchant 1618 may be based on the processing fees or processing amounts of the merchants 1636, 1638. The rebate amount of the ninth merchant 1620 may be based on the processing fees or processing amounts of the merchants 1640, 1642. The rebate amount of the tenth merchant 1622 may be based on the processing fees or processing amounts of the merchants 1644, 1646. The rebate amount of the eleventh merchant 1624 may be based on the processing fees or processing amounts of the merchants 1648, 1650. The rebate amount of the twelfth merchant 1626 may be based on the processing fees or processing amounts of the merchants 1652, 1654. The rebate amount of the thirteenth merchant 1628 may be based on the processing fees or processing amounts of the merchants 1656, 1658. The rebate amount of the fourteenth merchant 1630 may be based on the processing fees or processing amounts of the merchants 1660, 1662.

The rebate amount attributable to the processing fees generated by the third merchant 1608 and the fourth merchant 1610 may be the same for the participant 1602 and the first merchant 1604 or different for the participant 1602 and the first merchant 1604.

The rebate amount attributable to the processing fees generated by the fifth merchant 1612 and the sixth merchant 1614 may be the same for the participant 1602 and the second merchant 1606 or different for the participant 1602 and the second merchant 1606.

The rebate amount attributable to the processing fees generated by the seventh merchant 1612 and the eighth merchant 1618 may be the same for the participant 1602, the first merchant 1604, and/or the third merchant 1608 or different for the participant 1602, the first merchant 1604, and/or the third merchant 1608. The rebate amount attributable to the processing fees generated by the ninth merchant 1620 and the tenth merchant 1622 may be the same for the participant 1602, the first merchant 1604, and/or the fourth merchant 1610 or different for the participant 1602, the first merchant 1604, and/or the fourth merchant 1610.

The rebate amount attributable to the processing fees generated by the eleventh merchant 1624 and the twelfth merchant 1626 may be the same for the participant 1602, the second merchant 1606, and/or the fifth merchant 1612 or different for the participant 1602, the second merchant 1606, and/or the fifth merchant 1612. The rebate amount attributable to the processing fees generated by the thirteenth merchant 1628 and the fourteenth merchant 1630 may be the same for the participant 1602, the second merchant 1606, and/or the sixth merchant 1614 or different for the participant 1602, the second merchant 1606, and/or the sixth merchant 1614.

The rebate amount attributable to the processing fees generated by the fifteenth merchant 1632 and the sixteenth merchant 1634 may be the same for the participant 1602, the first merchant 1604, the third merchant 1608, and/or the seventh merchant 1616 or different for the participant 1602, the first merchant 1604, the third merchant 1608, and/or the seventh merchant 1616. The rebate amount attributable to the processing fees generated by the seventeenth merchant 1636 and the eighteenth merchant 1638 may be the same for the participant 1602, the first merchant 1604, the third merchant 1608, and/or the eighth merchant 1618 or different for the participant 1602, the first merchant 1604, the third merchant 1608, and/or the eighth merchant 1618.

The rebate amount attributable to the processing fees generated by the nineteenth merchant 1640 and the twentieth merchant 1642 may be the same for the participant 1602, the first merchant 1604, the fourth merchant 1610, and/or the ninth merchant 1620 or different for the participant 1602, the first merchant 1604, the fourth merchant 1610, and/or the ninth merchant 1620. The rebate amount attributable to the processing fees generated by the twenty-first merchant 1644 and the twenty-second merchant 1646 may be the same for the participant 1602, the first merchant 1604, the fourth merchant 1610, and/or the tenth merchant 1622 or different for the participant 1602, the first merchant 1604, the fourth merchant 1610, and/or the tenth merchant 1622.

The rebate amount attributable to the processing fees generated by the twenty-third merchant 1648 and the twenty-fourth merchant 1650 may be the same for the participant 1602, the second merchant 1606, the fifth merchant 1612, and/or the eleventh merchant 1624 or different for the participant 1602, the second merchant 1606, the fifth merchant 1612, and/or the eleventh merchant 1624. The rebate amount attributable to the processing fees generated by the twenty-fifth merchant 1652 and the twenty-sixth merchant 1654 may be the same for the participant 1602, the second merchant 1606, the fifth merchant 1612, and/or the twelfth merchant 1626 or different for the participant 1602, the second merchant 1606, the fifth merchant 1612, and/or the twelfth merchant 1626.

The rebate amount attributable to the processing fees generated by the twenty-seventh merchant 1656 and the twenty-eighth merchant 1658 may be the same for the participant 1602, the second merchant 1606, the sixth merchant 1614, and/or the thirteenth merchant 1628 or different for the participant 1602, the second merchant 1606, the sixth merchant 1614, and/or the thirteenth merchant 1628. The rebate amount attributable to the processing fees generated by the twenty-ninth merchant 1660 and the thirtieth merchant 1662 may be the same for the participant 1602, the second merchant 1606, the sixth merchant 1614, and/or the fourteenth merchant 1630 or different for the participant 1602, the second merchant 1606, the sixth merchant 1614, and/or the fourteenth merchant 1630.

In some embodiments, the participant 1602 may receive a greater rebate by having a full book of merchants. In one embodiment, the full book of merchants is having four levels of merchants, with at least two merchants at every level, and the merchants at each level having at least two downstream merchants. The greater rebate may be in the form of a bonus, a higher percentage of processing fees, or the like.

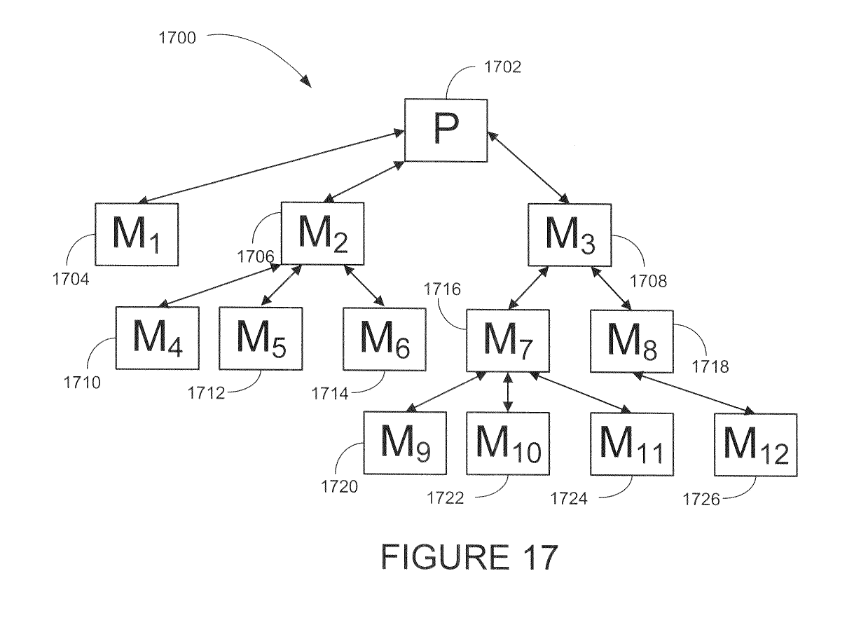

FIG. 17. is an example diagram 1700 of the referral relationships used in performing the method 1000, according to an example embodiment. The diagram 1700 includes a participant 1702, a first merchant 1704, a second merchant 1706, a third merchant 1708, a fourth merchant 1710, a fifth merchant 1712, and a sixth merchant 1714, a seven merchant 1716, an eighth merchant 1718, a ninth merchant 1720, a tenth merchant 1722, an eleventh merchant 1724, and a twelfth merchant 1726.

In the diagram 1700, the participant 1702 is shown to have referral relationships with the first merchant 1704, the second merchant 1706, and the third merchant 1708. The second merchant 1706 is shown to have referral relationships with the fourth merchant 1710, the fifth merchant 1712, and the sixth merchant 1714. The third merchant 1708 is show to have referral relationships with the seventh merchant 1716 and the eighth merchant 1718. The seventh merchant is shows to have referral relationships with the ninth merchant 1720, the tenth merchant 1722, and the eleventh merchant 1724. The eighth merchant is shown to have the referral relationship with the twelfth merchant. No other referral relationships are shown to exist in the diagram 1700.

The first merchant 1704, the second merchant 1706, and the third merchant 1708 are directly downstream from the participant 1702. The fourth merchant 1710, the fifth merchant 1712, and the sixth merchant 1714 are directly downstream from the second merchant 1706 and indirectly downstream from the participant 1702. The seventh merchant 1716 and the eighth merchant 1718 are directly downstream from the third merchant 1708 and indirectly downstream from the participant 1702. The ninth merchant 1720, the tenth merchant 1722, and the eleventh merchant 1724 are directly downstream from the seventh merchant 1716 and indirectly downstream from the participant 1702 and the third merchant 1708. The twelfth merchant 1726 is directly downstream from the eighth merchant 1718 and indirectly downstream from the participant 1702 and the third merchant 1708.

If the rebate earning limitation is that the participant 1702 or one of the merchants 1704-1726 have at least one downstream participant, then the participant 1702, the second merchant 1706, the third merchant 1708, the seventh merchant 1716, and the eighth merchant 1718 are eligible to earn rebates. If the rebate earning limitation is that the participant 1702 or one of the merchants 1704-1726 have at least two downstream participants, then the participant 1702, the second merchant 1706, the third merchant 1708, and the seventh merchant 1716 are eligible to earn rebates. If the rebate earning limitation is that the participant 1702 or one of the merchants 1704-1726 have at least three downstream participants, then the participant 1702, the second merchant 1706, and the seventh merchant 1716 are eligible to earn rebates.

The rebate amount of the participant 1702 may be based on the processing fees or processing amounts of the merchants 1704-1726. However, if there is a maximum level limitation of two, then the rebate amount for the participant 1702 will be based on the processing fees or processing amounts of the merchants 1704-1718.

The rebate amount of the first merchant 1704 will then be based on the processing fees or processing amounts of the merchants 1708-1722. However, if there is a maximum level limitation of two, then the rebate amount for the first merchant 1704 will be based on the processing fees or processing amounts of the merchants 1708-1714. If there is a maximum level limitation of three, then the rebate amount for the first merchant 1704 will be based on the processing fees or processing amounts of the merchants 1716-1718.

The rebate amount of the third merchant 1708 may be based on the processing fees or processing amounts of the merchants 1712-1722. However, if there is a maximum level limitation of two, then the rebate amount for the third merchant 1708 will be based on the processing fees or processing amounts of the merchants 1712-1718.

The rebate amount of the fifth merchant 1712 may be based on the processing fees or processing amounts of the merchants 1716-1722. The rebate amount of the seventh merchant 1716 may be based on the processing fees or processing amounts of the merchants 1720-1722.

The rebate amount attributable to the processing fees generated by the third merchant 1708 and the fourth merchant 1710 may be the same for the participant 1702 and the first merchant 1704 or different for the participant 1702 and the first merchant 1704.

The rebate amount attributable to the processing fees generated by the fifth merchant 1712 and the sixth merchant 1714 may be the same for the participant 1702, the first merchant 1704, and the third merchant 1708 or different for the participant 1702, the first merchant 1704, and the third merchant 1708.

The rebate amount attributable to the processing fees generated by the seventh merchant 1712 and the eighth merchant 1718 may be the same for the participant 1702, the first merchant 1704, the third merchant 1708, and/or the fifth merchant 1712 or different for the participant 1702, the first merchant 1704, the third merchant 1708, and/or the fifth merchant 1712.

The rebate amount attributable to the processing fees generated by the ninth merchant 1720 and the tenth merchant 1720 may be the same for the participant 1702, the first merchant 1704, the third merchant 1708, the fifth merchant 1712, and/or the seventh merchant 1716 or different for the participant 1702, the first merchant 1704, the third merchant 1708, the fifth merchant 1712, and/or the seventh merchant 1716.

In some embodiments, the processing fees or processing amounts of downstream merchants whose associated upstream merchants do not meet the rebate earning criteria may be excluded from the rebate amount. For example, the processing fees of the merchants 1718, 1726 may be excluded from the rebate amounts of the participant 1702 and the merchant 1708 if the rebate earning criteria is that the participant 1702 or one of the merchants 1704-1726 have at least one downstream participant. The processing fees of the merchants 1716-1726 may be excluded from the rebate amounts of the participant 1702.

In some embodiments, the participant may be located in a different position in the diagrams depicting referral relationships. In one embodiment, the participant may be a religious or charitable organization and the merchants may include merchants that want rebate amount for referring their card processing business to be paid to the religious or charitable organization.

In some embodiments, the referral relationships may include any number of levels. Each merchant in the referral relationships may be deemed a participant and earn rebates based on direct and indirect referral relationships.

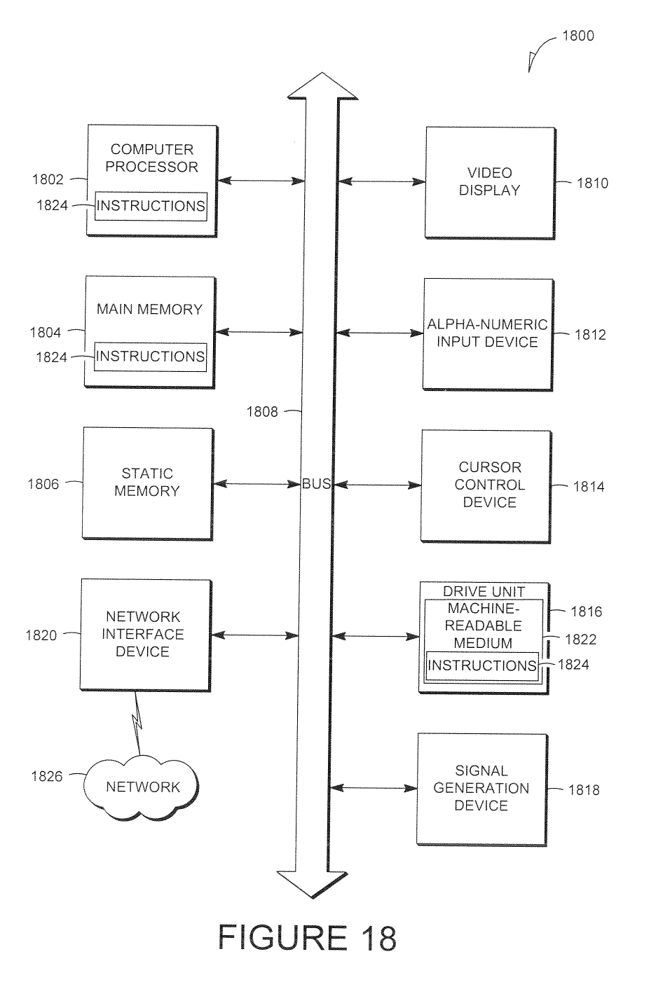

FIG. 18 shows a block diagram of a machine in the example form of a computer system 1800 within which a set of instructions may be executed causing the machine to perform any one or more of the methods, processes, operations, or methodologies discussed herein. The operator device 102, the data processing device 106, and/or the merchant services processing device 114 may include the functionality of the one or more computer systems 1800.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a computer processor 1802 (e.g., a central processing unit (CPU) a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a cursor control device 1814 (e.g., a mouse), a drive unit 1816, a signal generation device 1818 (e.g., a speaker) and a network interface device 1820.

The drive unit 1816 includes a machine-readable medium 1822 on which is stored one or more sets of instructions (e.g., software 1824) embodying any one or more of the methodologies or functions described herein. The software 1824 may also reside, completely or at least partially, within the main memory 1804 and/or within the processor 1812 during execution thereof by the computer system 1800, the main memory 1804 and the processor 1812 also constituting machine-readable media.

The software 1824 may further be transmitted or received over a network 1826 via the network interface device 1820.

While the machine-readable medium 1822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention. The term “machine-readable medium” shall accordingly be taken to include, but not be limited to, solid-state memories, and optical media, and magnetic media.

Certain systems, apparatus, applications or processes are described herein as including a number of modules. A module may be a unit of distinct functionality that may be presented in software, hardware, or combinations thereof. When the functionality of a module is performed in any part through software, the module includes a machine-readable medium. The modules may be regarded as being communicatively coupled.

In an example embodiment, a determination that a participant has a referral relationship with a first merchant may be made. A first processing fee of the first merchant may be obtained. The first processing fee may be based on a payment volume of the first merchant. A second processing fee of the second merchant may be obtained. The second processing fee may be based on the payment volume of the second merchant. A rebate amount for the participant may be calculated based on the first processing fee, the second processing fee, and a determination that the participant has the referral relationship with the first merchant.

In an example embodiment, a determination that a participant has a referral relationship with a first merchant may be made. A first processing amount of the first merchant may be obtained. The first processing amount may be based on a payment volume of the first merchant. A second processing amount of the second merchant may be obtained. The second processing amount may be based on the payment volume of the second merchant. A rebate amount for the participant may be calculated based on the first processing amount, the second processing amount, and a determination that the participant has the referral relationship with the first merchant.

Thus, methods and systems for amount calculation have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

Various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method comprising:
determining on a computer processor that a participant has a referral relationship with a first merchant;
obtaining on the computer processor a first processing fee of the first merchant, the first processing fee based on a payment volume of the first merchant;
obtaining on the computer processor a second processing fee of the second merchant, the second processing fee based on the payment volume of the second merchant; and
calculating on the computer processor a rebate amount for the participant based on the first processing fee, the second processing fee, and a determination that the participant has the referral relationship with the first merchant.

2. The method of claim 1, wherein calculating the rebate amount comprises:
calculating a first rebate portion by taking a first percentage of the first processing fee;
calculating a second rebate portion by taking a second percentage of the second processing fee; and
summing the first rebate portion and the rebate portion to determine the rebate amount.

3. The method of claim 2, wherein the first percentage is the same percentage as the second percentage.

4. The method of claim 1, further comprising:
determining that the first merchant has the referral relationship with the second merchant,
wherein calculation of the rebate amount for the participant is based on the first processing fee, the second processing fee, the determination that the participant has the referral relationship with the first merchant, and the determination that the first merchant has the referral relationship with the second merchant.

5. The method of claim 1, further comprising:
determining that the participant has the referral relationship with the second merchant,
wherein calculation of the rebate amount for the participant is based on the first processing fee, the second processing fee, and the determination that the participant has the referral relationship with the first merchant and the second merchant.

6. The method of claim 5, further comprising:
determining that the first merchant has the referral relationship with a third merchant and a fourth merchant, the participant and the second merchant not having the referral relationship with the third merchant, the fourth merchant, or both the third merchant and the fourth merchant;
obtaining a third processing fee of the third merchant, the third processing fee based on the payment volume of the third merchant;
obtaining a fourth processing fee of the fourth merchant, the fourth processing fee based on the payment volume of the fourth merchant; and
calculating the rebate amount for the first merchant based on the third processing fee, the fourth processing fee, and a determination that the first merchant has the referral relationship with the third merchant and the fourth merchant,
wherein calculation of the rebate amount for the participant is based on the first processing fee, the second processing fee, the third processing fee, and the fourth processing fee, the determination that the participant has the referral relationship with the first merchant and the second merchant, and a determination that the first merchant has the referral relationship with the third merchant and the fourth merchant.

7. The method of claim 6, wherein calculating the rebate amount for the participant comprises:
calculating a first rebate portion by taking a first percentage of the first processing fee;
calculating a second rebate portion by taking a second percentage of the second processing fee;
calculating a third rebate portion by taking a third percentage of the third processing fee;
calculating a fourth rebate portion by taking a fourth percentage of the fourth processing fee;
summing the first rebate portion, the second rebate portion, the third rebate portion, and the fourth rebate portion to determine the rebate amount of the participant, and
wherein calculating the rebate amount for the first merchant comprises summing the third rebate portion and the fourth rebate portion to determine the rebate amount of the first merchant.

8. The method of claim 6, further comprising:
determining that the third merchant has the referral relationship with a fifth merchant and a sixth merchant, the participant, the first merchant, the second merchant, and the fourth merchant not having the referral relationship with the fifth merchant, the sixth merchant, or both the fifth merchant and the sixth merchant;
obtaining a fifth processing fee of the fifth merchant, the fifth processing fee based on the payment volume of the fifth merchant;
obtaining a sixth processing fee of the sixth merchant, the sixth processing fee based on the payment volume of the sixth merchant; and
calculating the rebate amount for the third merchant based the fifth processing fee, the sixth processing fee, and a determination that the third merchant has the referral relationship with the fifth merchant and the sixth merchant,
wherein the calculation of the rebate amount for the participant is based on the first processing fee, the second processing fee, the third processing fee, the fourth processing fee, the fifth processing fee, the sixth processing fee, the determination that the participant has the referral relationship with the first merchant and the second merchant, the determination that the first merchant has the referral relationship with the third merchant and the fourth merchant, and the determination that the third merchant has the referral relationship with the fifth merchant and the sixth merchant, and
the calculation of the rebate amount for the first merchant is based on the third processing fee, the fourth processing fee, the fifth processing fee, and the sixth processing fee, the determination that the first merchant has the referral relationship with the third merchant and the fourth merchant, and the determination that the third merchant has the referral relationship with the fifth merchant and the sixth merchant.

9. The method of claim 8, further comprising:
determining that the fifth merchant has the referral relationship with a seventh merchant and a eighth merchant, the participant, the first merchant, the second merchant, the third merchant, the fourth merchant, and the sixth merchant not having the referral relationship with the seventh merchant, the eighth merchant, or both the seventh merchant and the eighth merchant;
obtaining a seventh processing fee of the seventh merchant, the seventh processing fee based on the payment volume of the seventh merchant;
obtaining an eighth processing fee of the eighth merchant, the eighth processing fee based on the payment volume of the eighth merchant; and
calculating the rebate amount for the fifth merchant based on the seventh processing fee, the eighth processing fee, and a determination that the fifth merchant has the referral relationship with the seventh merchant and the eighth merchant,
wherein the calculation of the rebate amount for the participant is based on the first processing fee, the second processing fee, the third processing fee, the fourth processing fee, the fifth processing fee, the sixth processing fee, the seventh processing fee, the eighth processing fee, the determination that the participant has the referral relationship with the first merchant and the second merchant, the determination that the first merchant has the referral relationship with the third merchant and the fourth merchant, the determination that the third merchant has the referral relationship with the fifth merchant and the sixth merchant, and the determination that the fifth merchant has the referral relationship with the seventh merchant and the eighth merchant,
the calculation of the rebate amount for the first merchant is based on the third processing fee, the fourth processing fee, the fifth processing fee, the sixth processing fee, the seventh processing fee, the eighth processing fee, the determination that the first merchant has the referral relationship with the third merchant and the fourth merchant, the determination that the third merchant has the referral relationship with the fifth merchant and the sixth merchant, and the determination that the fifth merchant has the referral relationship with the seventh merchant and the eighth merchant, and
the calculation of the rebate amount for the third merchant is based on the fifth processing fee, the sixth processing fee, the seventh processing fee, the eighth processing fee, the determination that the third merchant has the referral relationship with the fifth merchant and the sixth merchant, and the determination that the fifth merchant has the referral relationship with the seventh merchant and the eighth merchant.

10. The method of claim 8, further comprising:
determining that the seventh merchant has the referral relationship with a ninth merchant and a tenth merchant, the participant, the first merchant, the second merchant, the third merchant, and the fourth merchant, the fifth merchant, the sixth merchant, and the eighth merchant not having the referral relationship with the ninth merchant, the tenth merchant, or both the ninth merchant and the tenth merchant;
obtaining a ninth processing fee of the ninth merchant, the ninth processing fee based on the payment volume of the ninth merchant;
obtaining a tenth processing fee of the tenth merchant, the tenth processing fee based on the payment volume of the tenth merchant; and
calculating the rebate amount for the seventh merchant based on the ninth processing fee, the tenth processing fee, and a determination that the seventh merchant has the referral relationship with the ninth merchant and the tenth merchant,
wherein the calculation of the rebate amount for the first merchant is based on the third processing fee, the fourth processing fee, the fifth processing fee, the sixth processing fee, the seventh processing fee, the eighth processing fee, the ninth processing fee, the tenth processing fee, the determination that the first merchant has the referral relationship with the third merchant and the fourth merchant, the determination that the third merchant has the referral relationship with the fifth merchant and the sixth merchant, the determination that the fifth merchant has the referral relationship with the seventh merchant and the eighth merchant, and the determination that the seventh merchant has the referral relationship with the ninth merchant and the tenth merchant,
the calculation of the rebate amount for the third merchant is based on the fifth processing fee, the sixth processing fee, the seventh processing fee, the eighth processing fee, the ninth processing fee, the tenth processing fee, the determination that the third merchant has the referral relationship with the fifth merchant and the sixth merchant, the determination that the fifth merchant has the referral relationship with the seventh merchant and the eighth merchant, and the determination that the seventh merchant has the referral relationship with the ninth merchant and the tenth merchant, and
the calculation of the rebate amount for the fifth merchant is based on the seventh processing fee, the eighth processing fee, the ninth processing fee, the tenth processing fee, the determination that the fifth merchant has the referral relationship with the seventh merchant and the eighth merchant, and the determination that the seventh merchant has the referral relationship with the ninth merchant and the tenth merchant.

11. The method of claim 10, further comprising:
determining whether a maximum further referral level has been exceeded between the participant and the seventh merchant,
wherein the calculation of the rebate amount for the participant is based on the first processing fee, the second processing fee, the third processing fee, the fourth processing fee, the fifth processing fee, the sixth processing fee, the seventh processing fee, the eighth processing fee, the determination that the participant has the referral relationship with the first merchant and the second merchant, the determination that the first merchant has the referral relationship with the third merchant and the fourth merchant, the determination that the third merchant has the referral relationship with the fifth merchant and the sixth merchant, the determination that the fifth merchant has the referral relationship with the seventh merchant and the eighth merchant, and a determination that the maximum further referral level has been exceeded.

12. The method of claim 10, further comprising:
determining whether a maximum further referral level has been exceeded between the participant and the seventh merchant,
wherein the calculation of the rebate amount for the participant is based on the first processing fee, the second processing fee, the third processing fee, the fourth processing fee, the fifth processing fee, the sixth processing fee, the seventh processing fee, the eighth processing fee, the ninth processing fee, the tenth processing fee, the determination that the participant has the referral relationship with the first merchant and the second merchant, the determination that the first merchant has the referral relationship with the third merchant and the fourth merchant, the determination that the third merchant has the referral relationship with the fifth merchant and the sixth merchant, the determination that the fifth merchant has the referral relationship with the seventh merchant and the eighth merchant, the determination that the seventh merchant has the referral relationship with the ninth merchant and the tenth merchant, and a determination that the maximum further referral level has not been exceeded.

13. The method of claim 1, further comprising:
issuing a credit to the participant for the rebate amount.

14. The method of claim 1, wherein determining comprises:
accessing a referral list; and
determining that the participant is associated with the first merchant on the referral list.

15. The method of claim 1, wherein obtaining the first processing fee comprises calculating the first processing fee of the first merchant based on the payment volume of the first merchant, and obtaining the first processing fee comprises calculating the second processing fee of the second merchant based on the payment volume of the second merchant.

16. The method of claim 1, wherein obtaining the first processing fee comprises receiving the first processing fee of the first merchant from a card processor, and obtaining the first processing fee comprises receiving the second processing fee of the second merchant from the card processor.

17. The method of claim 1, wherein the participant is a merchant.

18. A method comprising:
determining on a computer processor that a participant has a referral relationship with a first merchant;
obtaining on the computer processor a first processing amount of the first merchant based on a payment volume of the first merchant;
obtaining on the computer processor a second processing amount of the second merchant based on the payment volume of the second merchant; and
calculating on the computer processor a rebate amount for the participant based on the first processing amount, the second processing amount, and a determination that the participant has the referral relationship with the first merchant.

19. A machine-readable medium comprising instructions, which when executed by one or more processors, cause the one or more processors to perform the following operations:
determine that a participant has a referral relationship with a first merchant;
obtain a first processing fee of the first merchant, the first processing fee based on a payment volume of the first merchant;
obtain a second processing fee of the second merchant, the second processing fee based on the payment volume of the second merchant; and
calculate a rebate amount for the participant based on the first processing fee, the second processing fee, and a determination that the participant has the referral relationship with the first merchant.
